(19) United States
(12) Patent Application Publication
(10) Pub. No.: US 2026/0328181 A1
(43) Pub. Date: Oct. 22, 2026

(54) A WIND TURBINE BLADE

(71) Applicant: Vestas Wind Systems A/S, Aarhus N. (DK)

(72) Inventor: Robin John Kennard, South Fremantle (AU)

(73) Assignee: Vestas Wind Systems A/S, Aarhus N. (DK)

(21) Appl. No.: 19/486,417

(22) PCT Filed: May 23, 2024
(86) PCT No.: PCT/DK2024/050121

§ 371 Date: Nov. 21, 2025

(30) Foreign Application Priority Data
May 25, 2023 (DK) PA202370250

(51) Int. Cl. F03D 1/06

(52) U.S. Cl. CPC F03D 1/0682; F03D 1/0688; F03D 1/069

(57) ABSTRACT

Aspects of the present disclosure relates to a wind turbine blade. The blade comprises a main reinforcement structure, the main reinforcement structure comprising a main windward reinforcement structure and a main leeward reinforcement structure; a rear reinforcement structure, the rear reinforcement structure comprising a rear windward reinforcement structure and a rear leeward reinforcement structure; and a trailing edge reinforcement structure arranged between the rear reinforcement structure and a trailing edge of the blade. The main windward reinforcement structure and the main leeward reinforcement structure comprise layers of pultruded fibres of a first material. The rear windward reinforcement structure and/or the rear leeward reinforcement structure comprise layers of pultruded fibres of a second material, the pultruded fibres of the first material having a Young's modulus greater than the pultruded fibres of the second material. The trailing edge reinforcement structure comprises fibres aligned with the trailing edge of the blade.

### TECHNICAL FIELD

The present invention relates to a wind turbine blade, particularly a wind turbine blade for a horizontal-axis wind turbine. The invention further relates to a method for manufacturing a wind turbine blade and use of a trailing edge reinforcement structure.

### BACKGROUND OF THE INVENTION

As a part of the worldwide transition into renewable energy, there is a demand for wind turbines of increased size and efficiency. Mechanical properties of wind turbine blades, however, impose limitations on the size of the blades and thus on the power output of wind turbines. During use, wind turbine blades are subject to static and dynamic loads incurred by the wind acting on the blades, i.e., aerodynamic loads, as well as gravitational loads.

Loads induced by wind acting on a wind turbine blade are generally referred to as flapwise loads, and loads induced by gravity are generally referred to as edgewise loads. During use of the blade, its pressure side is generally subjected to tension, and its suction side is generally subjected to compression.

The pressure side can also be referred to as the windward side, and the suction side can also be referred to as the leeward side.

To counteract loads on blades, reinforcement structures such as spar caps may be embedded or attached in wind turbine blades to engage with leeward and/or windward shell portions to provide enhanced tensile and/or compressive strength. Further, such reinforcement structures may be interconnected by shear webs. Reinforcement structures such as spar caps may include longitudinally aligned carbon fibres integrated in, e.g., pultruded elements which may be designed to resist a certain predetermined level of tensile and compressive loads.

Pultruded elements provide a high stiffness and are therefore used in many modern wind turbine blades. However, the geometry and stiffness of pultruded elements impose significant constraints as to how and where these elements can be positioned in the blade.

Generally, pultruded elements based on carbon fibres provide a greater stiffness than pultruded elements based on other materials, such as glass. However, pultruded elements based of carbon fibres are more expensive. Yet, simply using glass fibres instead of carbon fibres significantly increases the mass of the blade, which is not desirable.

As a result, it is generally challenging to design and manufacture wind turbine blades which have the necessary load-carrying capabilities in a cost-efficient manner.

Hence, there is a need for concepts which can provide wind turbine blades with improved load-carrying capabilities in a cost-efficient manner, without increasing the mass of the blade.

### SUMMARY OF THE INVENTION

On the above background, it is an object of preferred embodiments of the invention to provide a wind turbine blade with improved load-carrying capabilities, with no or even reduced cost in terms of increased blade mass and cost of materials. It is a further object of preferred embodiments to provide a blade design concept which permits adaptation of the blade design without requiring new manufacturing equipment for the blade shell.

A first aspect of the present disclosure relates to a wind turbine blade comprising:
a root end and a tip end, the blade extending in a spanwise direction between the root end and the tip end;
a leading edge and a trailing edge, the blade extending in a chordwise direction between the leading edge and the trailing edge;
a leeward shell and a windward shell, the blade extending in a thickness direction between the leeward shell and the windward shell;
a main reinforcement structure, the main reinforcement structure comprising a main windward reinforcement structure engaging the windward shell and extending in the spanwise direction of the blade and a main leeward reinforcement structure engaging the leeward shell and extending in the spanwise direction of the blade;
a rear reinforcement structure, the rear reinforcement structure comprising a rear windward reinforcement structure engaging the windward shell and extending in the spanwise direction of the blade and a rear leeward reinforcement structure engaging the leeward shell and extending in the spanwise direction of the blade, the rear reinforcement structure being arranged between the main reinforcement structure and the trailing edge; and a trailing edge reinforcement structure extending in the spanwise direction of the blade and being arranged between the rear reinforcement structure and the trailing edge; wherein:
the main windward reinforcement structure and the main leeward reinforcement structure comprise layers of pultruded fibres of a first material;
the rear windward reinforcement structure and/or the rear leeward reinforcement structure comprise layers of pultruded fibres of a second material, the pultruded fibres of the first material having a Young's modulus greater than the pultruded fibres of the second material; and
the trailing edge reinforcement structure comprises fibres of a trailing edge reinforcement material aligned with the trailing edge of the blade and engaging the leeward shell and/or the windward shell.

A conventional wind turbine blade can, for example, have a main reinforcement structure and a rear reinforcement structure comprising layers of pultruded fibres of carbon. The main reinforcement structure may typically be directed at carrying the flapwise loads acting on the blade, and the rear reinforcement structure may typically be directed at carrying the edgewise loads acting on the blade, at least primarily.

In a conventional blade, even though layers of pultruded fibres of carbon in the rear reinforcement structure may increase the edgewise stiffness of the blade, the placement of the rear leeward reinforcement structure and the rear windward reinforcement structure is significantly constrained due to the airfoil shape of the blade. As a result, the ability of the rear reinforcement structures to resist edgewise bending may be suboptimal.

According to the present disclosure, in comparison with a conventional blade, layers of the rear reinforcement structure have been replaced with pultruded layers of a material having a lower Young's modulus, for example layers of pultruded fibres of carbon have been replaced with layers of pultruded fibres of glass. To yet provide the required edgewise load-carrying capability, a trailing edge reinforcement structure arranged between the rear reinforcement structure and the trailing edge is provided. This trailing edge reinforcement structure does not rely on pultruded elements, but may instead rely on, e.g., fibres unidirectionally arranged in a fabric of material. In isolation, such a trailing edge reinforcement structure typically has a lower stiffness than a pultruded element. However, its positioning does not suffer from the same constraints as pultruded elements, which are restricted in relation to placement in the blade due to size and rigidity of these elements and due to the airfoil shape of the blade. Thereby, the trailing edge reinforcement structure can be located between the rear reinforcement structure and the trailing edge, which results in an efficient way of stiffening the blade to resist edgewise bending loads. As the trailing edge reinforcement structure can be positioned close to or at the trailing edge of the blade, it is far from the neutral axis of the blade (compared to the rear reinforcement structures). This means that the trailing edge reinforcement structure is better placed for contributing to the edgewise stiffness of the blade than the rear reinforcement structures. In particular, it provides a greater second moment of inertia. This allows the trailing edge reinforcement structure to compensate for the lower stiffness of the rear reinforcement structure.

The provision of a rear reinforcement structure comprising layers of a second material and the trailing edge reinforcement structure also typically leads to an increase in the torsional stiffness of the blade, which improves the ability of the blade to resist torsional loading and improved aerodynamic stability. Thereby, the provision of a rear reinforcement structure comprising layers of a second material and a trailing edge reinforcement structure can provide wind turbine blades with improved load carrying capabilities, in particular with respect to edgewise stiffness and/or torsional stiffness, in a cost-efficient manner, without substantially increasing the mass of the blade.

The provision of a trailing edge reinforcement structure generally allows a reallocation of how edgewise bending loads are dealt with by various load-carrying structures of the blade. As a further result of such a reallocation, the geometry of blades may not suffer from the same restrictions as conventional blades in which pultruded reinforcement structures have to be integrated in a certain manner. Thereby, the provision of a trailing edge reinforcement structure may additionally permit better airfoil shapes to be utilized, since the placement of the main reinforcement structure and/or, in particular, the rear reinforcement structure can be more flexible.

Further, the concept of reducing the stiffness of the rear reinforcement structure and compensating by providing a trailing edge reinforcement structure can be utilized to improve flexibility of wind turbine blade production.

Conventionally, a given wind turbine blade of a particular size is typically designed and manufactured to meet a certain set of requirements with respect to edgewise and flapwise loads under a particular set of operation conditions. Such operation conditions may for example be local weather conditions, required lifetime/maintenance of the blades, power output of the wind turbine, etc. A blade design for one set of operation conditions is typically not optimal for another set of operation conditions. Yet, redesigning the entire blade is a cumbersome process and will typically require new manufacturing equipment such as new shell moulds.

The concept of a rear reinforcement structure comprising layers of pultruded fibres of a second material in combination with a trailing edge reinforcement structure generally allows blades to be flexibly redesigned, for example by redistributing stiffness between the main reinforcement structure, the rear reinforcement structure, and the trailing edge reinforcement structure, in particular between the rear reinforcement structure and the trailing edge reinforcement structure. Further, the exact distribution and number of fibres in the trailing edge reinforcement structure can be varied among blades. Such redistribution of stiffness can be performed without substantially changing the blade manufacturing process. For example, the same shell mould can be used to manufacture blades in which the number or material of pultruded layers in the rear reinforcement structure is different among the blades. Accordingly, the present disclosure introduces a blade design which permits adaptation of the blade design without requiring new manufacturing equipment or processes.

Typically, the leeward shell is the portion of the shell of the wind turbine blade located at a leeward side of the wind turbine blade. Similarly, the windward shell is typically the portion of the shell of the wind turbine blade located at the windward side of the wind turbine blade. The leeward shell and the windward shell may be interconnected at the trailing edge and/or at the leading edge.

The leeward shell and the windward shell typically define an airfoil profile of the wind turbine blade configured to generate a lift corresponding to an aerodynamic pressure difference between the windward shell portion and the leeward shell portion.

Part of the wind turbine blade may have a truncated trailing edge to define a flatback airfoil section. A flatback airfoil section can provide improved aerodynamic properties, and the reduced chord makes the blade easier to produce and transport. The flatback section can also provide an area which is particularly well-suited to accommodate a trailing edge reinforcement structure and the trailing edge reinforcement structure can provide the required edgewise load-carrying capability in this flatback section. Preferably therefore, the trailing edge reinforcement structure is arranged adjacent to the truncated trailing edge.

A windward/leeward reinforcement structure according to the present disclosure typically extends in the spanwise direction. It engages with a shell to thereby resist deformation of that shell, thereby counteracting flapwise and edgewise bending and/or torsional loads. A reinforcement structure may be integrated into a shell portion or bonded to a shell portion to engage that shell portion. An example of a reinforcement structure is a spar cap known per se.

Wind turbine blades according to examples of the present disclosure comprise both a main reinforcement structure and a rear reinforcement structure, each of these arrangements comprising at least two reinforcement structures, one engaging each respective shell. The leeward/windward reinforcement structures of the main reinforcement structure typically resist deformation of a leading part of the blade, and may in particular resist flapwise bending. The leeward/windward reinforcement structures of the rear reinforcement structure resist deformation of a trailing part of the blade, and may in particular resist edgewise bending.

The rear reinforcement structure may be arranged so that it is non-parallel to the main reinforcing structure. The leeward/windward reinforcement structures of the main reinforcement structure may be arranged non-parallel to the leeward/windward reinforcement structures of the rear reinforcement structure. The non-parallel arrangement is seen in a planform view of the blade, looking in the thickness direction down on the blade.

Arranging the rear reinforcement structure so that it is non-parallel to the main reinforcing structure allows the rear reinforcement structure to be more closely positioned to the trailing edge over its length so that it can resist deformation of the trailing edge of the blade.

The leeward/windward reinforcement structures of a reinforcement structure may be interconnected by a shear web. For example, the main leeward reinforcement structure and the main windward reinforcement structure may be interconnected by at least one main web, and/or the rear leeward reinforcement structure and the rear windward reinforcement structure may be interconnected by at least one rear web.

Typically, the main reinforcement structure comprises two reinforcement structures, but in some examples, the main reinforcement structure comprises more than two windward/leeward reinforcement structures, for example three windward/leeward reinforcement structures or four windward/leeward reinforcement structures.

Similarly, the rear reinforcement structure typically comprises two windward/leeward reinforcement structures, but it may comprise more reinforcement structures, such as three or four windward/leeward reinforcement structures.

In case a reinforcement structure comprises more than two windward/leeward reinforcement structures, these are typically interconnected by more than one shear web.

Typically, the first material, the second material, and the trailing edge reinforcement material may be any of carbon and glass. However, examples of the present disclosure are not limited to these fibres. For example, any of the first material, the second material, and the trailing edge reinforcement material may be natural fibres.

In examples of the present disclosure, the pultruded fibres of the first material have a Young's modulus greater than the fibres of the trailing edge reinforcement material.

For example, the first material is carbon and the trailing edge reinforcement material is glass. In examples of the present disclosure, the first material is carbon.

In examples of the present disclosure, the second material and/or the trailing edge reinforcement material is glass.

The provision of pultruded fibres of a first material having a Young's modulus greater than the pultruded fibres of the second material and/or greater than fibres of the trailing edge reinforcement material may advantageously ensure that the main reinforcement structure provides the necessary overall stiffness of the blade, particularly the flapwise stiffness, while the trailing edge reinforcement structure can be implemented in a cost-efficient manner.

Fibres of materials having such properties may advantageously be implemented as carbon and/or glass fibres, which can ensure that the blade can be manufactured cost-efficiently.

In examples of the present disclosure, the fibres of the trailing edge reinforcement structure are primarily unidirectionally arranged in a fabric of material.

In examples of the present disclosure, the fabric of material is in the form of tape.

According to the present disclosure, when fibres of the trailing edge reinforcement structure are primarily unidirectionally arranged in a fabric, at least 70% of the fibres are aligned, for example at least 80% of the fibres are aligned, such as at least 90% of the fibres are aligned. Preferably, the fibres of the trailing edge reinforcement structure are aligned with the trailing edge of the blade locally, so that as the trailing edge changes direction, so do the direction of the fibres. The trailing edge changes direction due to its curvature along the spanwise direction.

An example of fibres of the trailing edge reinforcement material in the trailing edge reinforcement structure being primarily unidirectionally arranged in a fabric of material in the form of tape is unidirectional tape (UD tape).

The provision of a fabric of material, in particular in the form of a tape, may ensure that the trailing edge reinforcement structure can be easily applied to engage the leeward shell and/or the windward shell during any step of manufacturing the blade. Further, such implementation of fibres can ensure that the fibres can be adapted to the shape of the trailing edge, which typically has a non-linear curvature along the spanwise direction which does not allow straightforward implementation of, e.g., pultruded layers of fibres. Preferably therefore, the trailing edge reinforcement structure does not comprise pultruded elements.

In examples of the present disclosure, wherein the trailing edge reinforcement structure forms skins around a sandwich core of the leeward shell and/or the windward shell.

Such implementation of a trailing edge reinforcement structure may ensure that the full surface area near the trailing edge is utilized, thereby maximizing the efficiency of the trailing edge reinforcement structure.

In examples of the present disclosure, the rear reinforcement structure comprises layers of pultruded fibres of the first material.

Such hybrid reinforcement structure may ensure that a cost-efficient balance of weight and stiffness can be obtained.

Further, although a rear reinforcement structure is typically directed at edgewise stiffness, a hybrid reinforcement structure may ensure that a substantial flapwise stiffness is maintained, regardless of stiffness being shifted from the rear reinforcement structure to the trailing edge reinforcement structure.

In examples of the present disclosure, in the rear reinforcement structure, the layers of pultruded fibres of the first material are nearer an outer surface of the blade than the layers of pultruded fibres of the second material.

In examples of the present disclosure, in the rear reinforcement structure, the layers of pultruded fibres of the first material extend further in the spanwise direction towards the tip end than the layers of pultruded fibres of the second material.

In typical reinforcement structures, layers of pultruded fibres terminate at different positions along the spanwise direction of the blade.

The provision of layers of pultruded fibres of the first material nearer an outer surface and/or extending further in the spanwise direction than the layers of pultruded fibres of the second material may ensure that the greater stiffness provided by the layers of pultruded fibres of the first material are maximally utilized.

In examples of the present disclosure, within an airfoil section of the wind turbine blade, the main windward reinforcement structure and the main leeward reinforcement structure have a first average Young's modulus in the spanwise direction and the rear windward reinforcement structure and the rear leeward reinforcement structure have a second average Young's modulus in the spanwise direction, wherein the first average elastic modulus and the second average elastic modulus are determined with respect to unit area of the respective reinforcement structure perpendicular to the spanwise direction, wherein a ratio of the first average Young's modulus to the second average Young's modulus is between 1.1 and 2.6, for example between 1.2 and 2.2, such as between 1.3 and 1.7.

Such a ratio Young's moduli may for example be a result of the use of pultruded fibres of different materials. Replacement of layers of pultruded fibres of carbon with layers of pultruded fibres of glass in the rear reinforcement structure will generally tend to decrease the second average elastic modulus, i.e., increase the ratio of the first average elastic modulus to the second average elastic modulus.

A ratio of moduli within the above-exemplifies ranges may for example ensure a proper balance between edgewise and flapwise stiffness in a cost-efficient manner.

In examples of the present disclosure, along at least a part of an extension of the trailing edge reinforcement structure along the spanwise direction, a chordwise distance between the rear reinforcement structure and the trailing edge in the chordwise direction is greater than a chordwise gap, wherein the chordwise gap is at least 15% of a chord length from the trailing edge to the leading edge, for example at least 20%, for example at least 25%, such as at least 30%.

The relative effect of redistributing stiffness from the rear reinforcement structure to a trailing edge reinforcement structure is particularly pronounced in blades which have a significant chordwise gap between the trailing edge and the rear reinforcement structure, for example due to an airfoil shape which does not permit pultruded layers of fibre to engage the shells near the trailing edge. Furthermore, the relative effect of redistributing stiffness may be particularly pronounced when the chordwise distance is greater than the chordwise gap along a spanwise range having significant extent in the spanwise direction.

Accordingly, the provision of a trailing edge reinforcement structure is particularly advantageous in case a chordwise distance between the rear windward reinforcement structure and the trailing edge is greater than a chordwise gap of a certain magnitude.

Furthermore, the provision of a trailing edge reinforcement structure permits improved airfoil shapes, such as airfoil shapes with a greater chordwise distance.

In examples of the present disclosure, the chordwise distance is greater than the chordwise gap within an entirety of a spanwise range along the spanwise direction, wherein the spanwise range is at least 20% of a spanwise length from the root end to the tip end, for example at least 30%, for example at least 40%, such as at least 50%.

The provision of a trailing edge reinforcement structure is particularly advantageous in case the chordwise distance between the rear windward reinforcement structure and the trailing edge is greater than the chordwise gap at least along a spanwise range of a certain magnitude.

In examples of the present disclosure, within an airfoil section of the wind turbine blade, the main reinforcement structure has a first stiffness in the spanwise direction and the rear reinforcement structure has a second stiffness in the spanwise direction, wherein a ratio of the first stiffness to the second stiffness is at least 2.0, for example at least 3.0, such as at least 4.0.

In conventional blades, the main reinforcement structure typically has a stiffness greater than the rear reinforcement structure. However, in examples according to examples of the present disclosure, the ratio of these stiffnesses is greater than in conventional blades, as exemplified in the above-provided ranges. In combination with the provision of a trailing edge reinforcement structure, this may ensure that the required edgewise and flapwise stiffness properties of the blade are provided in a cost-efficient manner.

The stiffness of an element is a measure which is indicative of the extent to which an object resists deformation in response to an applied force. Typically, the stiffness k is quantified as k=F/d, where F is a force and d is a displacement.

The stiffness is different from the elastic modulus of a material, but the stiffness of a given reinforcement structure does depend on the elastic modulus of the material or materials, from which that reinforcement structure is made. For example, for an exemplary element the stiffness is k=E×A/L, where E is the elastic modulus, A is cross-sectional area (transverse to direction of tension/compression) and L is the length of the element.

Examples of the present disclosure provide a particular ratio of a first stiffness (of a main reinforcement structure) to a second stiffness (of a rear reinforcement structure) at a given airfoil section of the wind turbine blade. The airfoil section is transverse to the spanwise direction.

In examples of the present disclosure, within the airfoil section, the trailing edge reinforcement structure has a third stiffness in the spanwise direction, wherein a ratio of the third stiffness to the second stiffness is between 0.05 and 0.50, for example between 0.10 and 0.40, such as between 0.15 and 0.30.

These exemplified ratios of the third stiffness to the second stiffness may ensure that the required edgewise and flapwise stiffness properties of the blade are provided in a cost-efficient manner.

For some types of reinforcement structures, the stiffness in tension and the stiffness in compression may be different. In such cases, the relevant stiffnesses may be the stiffnesses in tension. That is, in some examples of the present disclosure, the first stiffness, the second stiffness and the third stiffness are tensional stiffnesses.

In examples of the present disclosure, the trailing edge reinforcement structure is aligned with the trailing edge of the blade along a mid-span section of the blade in which the trailing edge has a non-linear curvature along the spanwise direction.

The non-linear curvature of the trailing edge is in a chordwise direction of the blade. In other words, when looking down on the blade in the thickness direction (the thickness direction being substantially perpendicular to the chordwise direction and substantially perpendicular to the spanwise direction) the non-linear curvature will be seen along the trailing edge.

Placement of a trailing edge reinforcement structure in such a section of the blade may advantageously ensure optimal resistance of edgewise bending and/or torsional loads.

In examples of the present disclosure, the main reinforcement structure comprises a main web interconnecting the main windward reinforcement structure and the main leeward reinforcement structure; and/or the rear reinforcement structure comprises a rear web interconnecting the rear windward reinforcement structure and the rear leeward reinforcement structure.

As a result, the leeward and windward reinforcement structures can be rigidly interconnected. In examples of the present disclosure, the trailing edge reinforcement structure engages the leeward shell and/or the windward shell.

In examples of the present disclosure, the main reinforcement structure extends further in the spanwise direction towards the tip end than the rear reinforcement structure and/or the trailing edge reinforcement structure.

Accordingly, an advantageous balance between edgewise and flapwise resistance from the reinforcement structures may be obtained.

In examples of the present disclosure, within the airfoil section of the wind turbine blade, the rear reinforcement structure has a first section mass and the trailing edge reinforcement structure has a second section mass, wherein a ratio of the first section mass to the second section mass is between 2.0 and 10.0, for example between 3.0 and 8.0, such as between 4.0 and 6.0.

These exemplified ratios of the third stiffness to the second stiffness may ensure that the required edgewise and flapwise stiffness properties of the blade are provided in a cost-efficient manner.

A second aspect of the present disclosure relates to a method for manufacturing a wind turbine blade, the method comprising the steps of:
engaging a main windward reinforcement structure with a windward shell and a main leeward reinforcement structure with a leeward shell, wherein the main windward reinforcement structure and the main leeward reinforcement structure comprise layers of pultruded fibres of a first material;
engaging a rear windward reinforcement structure with the windward shell and a rear leeward reinforcement structure with the leeward shell, wherein the rear windward reinforcement structure and/or the rear leeward reinforcement structure comprise layers of pultruded fibres of a second material, the pultruded fibres of the first material having a Young's modulus greater than the pultruded fibres of the second material;
forming the wind turbine blade from the leeward shell and the windward shell such that the wind turbine blade extends in a spanwise direction between a root end and a tip end of the blade, in a thickness direction between the leeward shell and the windward shell, and in a chordwise direction between a leading edge and a trailing edge of the blade,
   wherein the main windward reinforcement structure, the main leeward reinforcement structure, the rear windward reinforcement structure, and the rear leeward reinforcement structure each extend in the spanwise direction of the blade,
   wherein the main windward reinforcement structure and the main leeward reinforcement structure forms a main reinforcement structure and the rear windward reinforcement structure and the rear leeward reinforcement structure forms a rear reinforcement structure arranged between the main reinforcement structure and the trailing edge; and
engaging a trailing edge reinforcement structure with the wind turbine blade such that the trailing edge reinforcement structure extends in the spanwise direction and is arranged between the rear reinforcement structure and the trailing edge,
   wherein the trailing edge reinforcement structure comprises fibres of a trailing edge reinforcement material aligned with the trailing edge of the blade and engaging the leeward shell and/or the windward shell.

The second aspect directed at manufacturing a wind turbine blade may be used to manufacture a wind turbine blade according to the first aspect, and may thereby potentially provide the same or similar technical effects or advantages.

A third aspect of the present disclosure relates to use of the trailing edge reinforcement structure of a wind turbine blade according to any of claims 1-13 to resist edgewise loads in the wind turbine blade, wherein the trailing edge reinforcement structure constitutes at least 20% of an edgewise stiffness of the wind turbine blade, for example at least 25%, such as at least 30%.

### BRIEF DESCRIPTION OF THE DRAWINGS

Embodiments of the invention will now be further described by reference to the accompanying drawings, in which:

FIG. 1 illustrates main structural components of an exemplary horizontal-axis wind turbine comprising three wind turbine blades,

FIG. 2 illustrates a windward shell according to an example of a wind turbine blade according to the present disclosure,

FIG. 3 illustrates a cross-sectional view of a wind turbine blade comprising the windward shell illustrated in FIG. 2,

FIG. 4 illustrates a chordwise distance between the rear reinforcement structure and the trailing edge according to the present disclosure,

FIG. 5 illustrates the chordwise distance relative to the chord length along the spanwise direction of a wind turbine blade according to the present disclosure,

FIG. 6 illustrates a rear windward reinforcement structure of an exemplary wind turbine blade according to the present disclosure, and

FIG. 7 illustrates a flow chart of a method of manufacturing a wind turbine blade according to an embodiment of the present disclosure.

### DETAILED DESCRIPTION OF THE DRAWINGS

It should be understood that the detailed description and specific examples, while indicating embodiments of the disclosure, are given by way of illustration only, since various changes and modifications within the scope of the disclosure will become apparent to those skilled in the art from this detailed description.

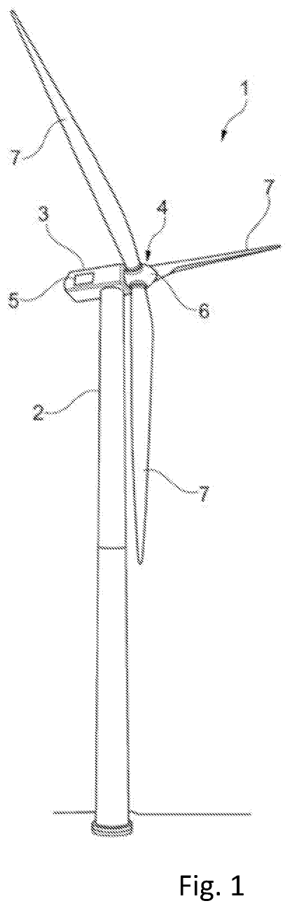

FIG. 1 illustrates main structural components of an exemplary horizontal-axis wind turbine 1 comprising three wind turbine blades 7 constituting the rotor 4 of the wind turbine. The wind turbine 1 comprises a tower 2 and a nacelle 3 mounted at top of the tower 2. The rotor is operatively coupled to a generator 5 within the nacelle 3 via a drive train (not shown) for converting mechanical kinetic energy harvested from the wind into electrical energy. In addition to the generator 5, the nacelle 3 may house additional components required to operate and optimize the performance of the wind turbine 1. The tower 2 supports the load presented by the nacelle 3, the rotor 4, and other wind turbine components within the nacelle 3.

The rotor 4 includes a central hub 6 and three elongated wind turbine blades 7 extending radially outward from the central hub 6, i.e., longitudinally in a lengthwise direction, from a root section of the blades 7 at the hub 6 to a tip section of the blades. In operation, the blades 7 are configured to interact with the passing air flow to produce lift that causes the central hub 6 to rotate about the longitudinal axis of the rotor 4. Wind speed in excess of a minimum level will activate the rotor 4 and allow it to rotate within a plane substantially perpendicular to the direction of the wind. The rotation is converted to electric power by the generator 5 and is usually supplied to the utility grid.

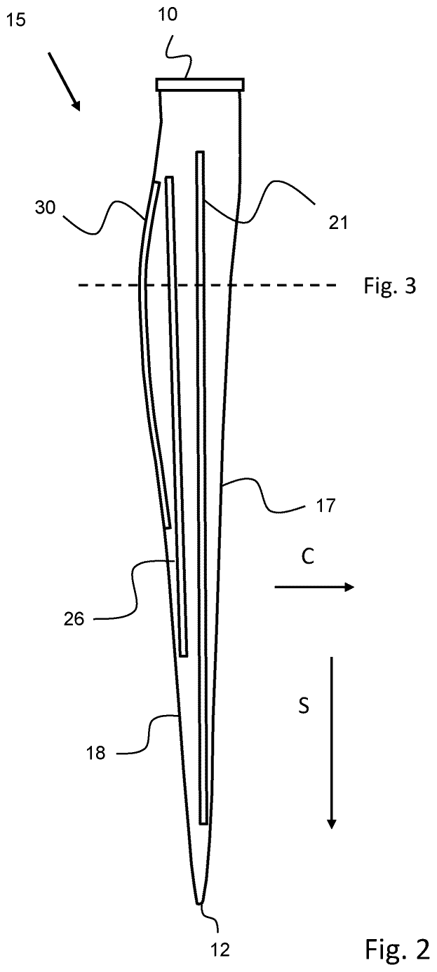

FIG. 2 illustrates a windward shell 15 according to an example of a wind turbine blade according to the present disclosure.

Wind turbine blades according to the present disclosure further comprises a leeward shell, which is not illustrated in FIG. 2. The leeward shell and the illustrated windward shell are joined along a leading edge 17 and along a trailing edge 18 of the wind turbine blade. The leeward shell and the windward shell may be formed as a single part.

The windward shell 15 extends in a chordwise direction between a leading edge 17 and a trailing edge 18 of the wind turbine blade. The chordwise direction is indicated in the figure by an arrow labelled with the letter “C”.

Further, the windward shell 15 and the wind turbine blade extend in a spanwise direction between a root end 10 and a tip end 12 of the wind turbine blade. The spanwise direction is indicated in the figure by an arrow labelled with the letter “S”. The spanwise direction is substantially perpendicular to the chordwise direction.

A main windward reinforcement structure 21 and a rear windward reinforcement structure 26 engages the windward shell to mechanically reinforce the windward shell 15, thereby counteracting the loads which the wind turbine blade is subject to during operation. Each of the reinforcement structures 21, 26 extend in the spanwise direction.

In this particular example, the two windward reinforcement structures 21, 26 are provided as spar caps. These may be embedded in the windward shell 15 via a resin infusion process.

Corresponding reinforcement structures can be provided in the leeward shell, and the reinforcement structures of the windward shell and the leeward shell can be interconnected by shear webs. The main windward reinforcement structure and the main leeward reinforcement structure interconnected by a main web can thereby form a main reinforcement structure, and the rear windward reinforcement structure and the rear leeward reinforcement structure interconnected by a rear web can thereby form a rear reinforcement structure of the blade.

In this example, the main windward reinforcement structure 21 comprise layers of pultruded fibres of a first material which is carbon. In comparison, the rear windward reinforcement structure 26 comprises pultruded fibres of a second material which is glass. Fibres of carbon have a Young's modulus which is greater the fibres of glass, thereby providing a more efficient strengthening of the shell. In addition, the main reinforcement structure typically has more layers of pultruded fibres than the rear reinforcement structure.

In the present example, a trailing edge reinforcement structure 30 is provided. This reinforcement structure 30 is arranged between the rear windward reinforcement structure 26 and the trailing edge 18. It comprises fibres of glass engaging the windward shell 15 and aligned with the trailing edge 18 of the blade.

In this particular example, the trailing edge reinforcement structure 30 is provided in the form of a tape, in which the fibres of glass are arranged in a unidirectional cloth material. This permits the trailing edge reinforcement structure 30 to conform to the non-linear curvature of the trailing edge 18.

As evident from the figure, the rear windward reinforcement structure 26 is highly restricted regarding positioning in the chordwise direction. In particular, the trailing edge 18 obstructs the rear windward reinforcement structure 26 from being shifted further towards the trailing edge 18 since the end of the rear windward reinforcement structure 26 towards the tip end 12 is already near the trailing edge 18. The trailing edge reinforcement structure 30 is less restricted and can thereby be located closer to the trailing edge 18 to provide efficient edgewise and/or torsional stiffness of the wind turbine blade.

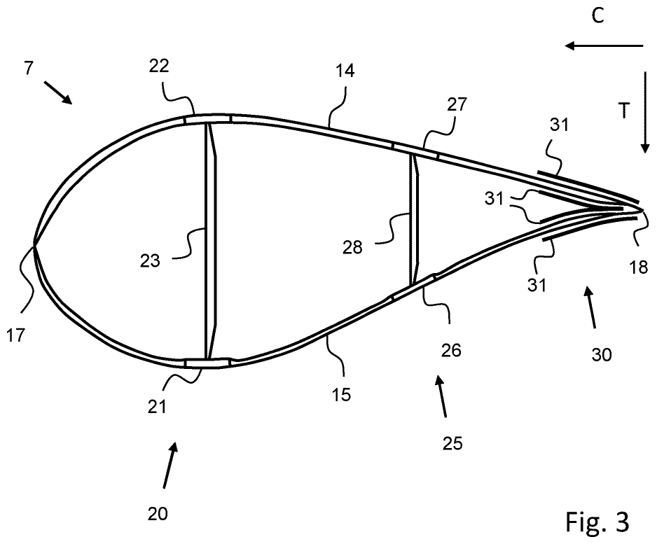

FIG. 3 provides a cross-sectional view of a wind turbine blade 7 comprising the windward shell 15 illustrated in FIG. 2. The illustrated cross-sectional view corresponds to a chordwise plane of the windward shell 15 of FIG. 2 indicated by a horizontal dashed line in FIG. 2 with reference to FIG. 3. The cross-sectional view additionally illustrates the leeward shell 14 joined with the windward shell 15 along the leading edge 17 and the trailing edge 18 of the wind turbine blade. As in FIG. 2, the chordwise direction is indicated in the figure by an arrow labelled with the letter “C”.

Further, the illustrated wind turbine blade 7 extend in a thickness direction between the leeward shell 14 and the windward shell. The thickness direction is indicated in the figure by an arrow labelled with the letter “T”. The thickness direction is substantially perpendicular to the chordwise direction and substantially perpendicular to the spanwise direction.

The illustrated wind turbine blade 7 comprises a main reinforcement structure 20, which in turn comprises a main windward reinforcement structure 21, a main leeward reinforcement structure 22, and a main web 23 interconnecting the main windward and main leeward reinforcement structures 21, 22.

Similarly, the blade 7 comprises a rear reinforcement structure 25, which in turn comprises a rear windward reinforcement structure 26, a rear leeward reinforcement structure 27, and a rear web 28 interconnecting the rear windward and rear leeward reinforcement structures 26, 27.

The main and rear windward reinforcement structures 21, 26 engage the windward shell 15, and the main and rear leeward reinforcement structures 22, 27 engage the leeward shell 14. The main windward and main leeward reinforcement structures 21, 22 each comprise layers of pultruded fibres of a first material which in this example is carbon. In comparison, the rear windward and rear leeward reinforcement structures 26, 27 each comprises layers of pultruded fibres of a second material which in this example is glass.

Moreover, the illustrated blade 7 comprises a trailing edge reinforcement structure 30. The trailing edge reinforcement structure 30 is provided as unidirectionally (UD) arranged fibres. In this example, the UD fibres are in a fabric of material 31 in the form of tape. Unidirectional tape 31 engages the blade 7 at an outer surface of the leeward shell 14, at an inner surface of the leeward shell 14, at an outer surface of the windward shell 15, and at in inner surface of the windward shell 15. In other examples, unidirectional fibre cloth tape only engages a subset of these surfaces, for example the outer surfaces, or the inner surfaces.

The fibres of the unidirectional tape 31 are aligned with the trailing edge 18 of the blade. In particular, the fibres are aligned with the trailing edge of the blade locally, so that as the trailing edge changes direction, so do the direction of the fibres. The trailing edge changes direction due to its curvature along the spanwise direction.

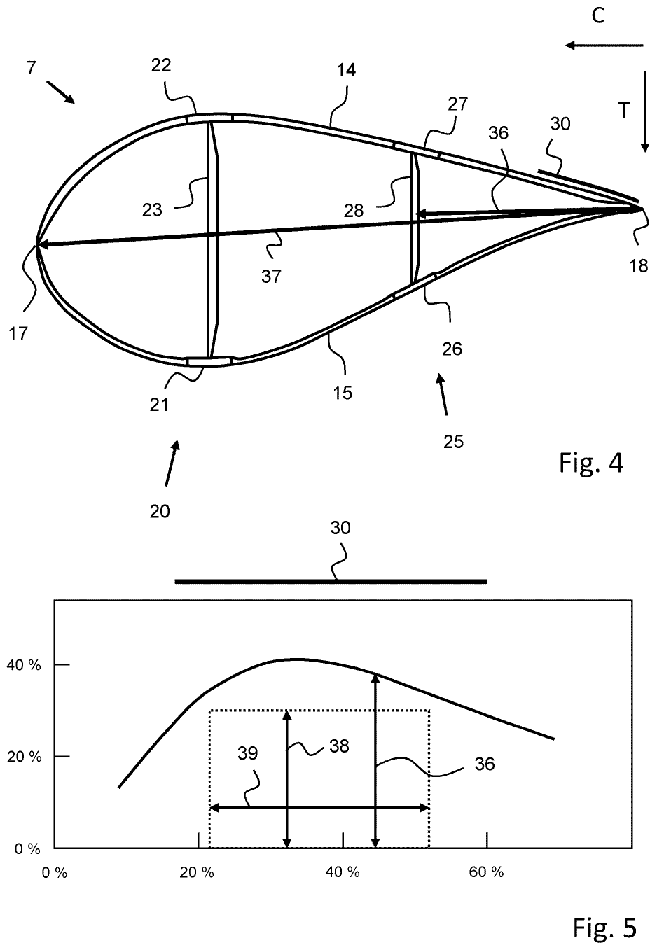

FIG. 4 illustrates a chordwise distance 36 between the rear reinforcement structure 25 and the trailing edge 18 according to the present disclosure.

The illustrated cross-sectional view of a wind turbine blade 7 is substantially similar to the cross-sectional view of the blade illustrated in FIG. 3, but the trailing edge reinforcement structure 30 is only provided onto the outer surface of the leeward shell 14.

The illustrated chordwise distance 36 is relevant since a trailing edge reinforcement structure 30 according to the present disclosure is particularly advantageous for wind turbine blades in which this chordwise distance 36 is a relatively large fraction of the chord length 37 from the trailing edge 18 to the leading edge 17.

For a given chordwise plane at a particular spanwise position of the blade 7, the chordwise distance 36 at that chordwise plane should be compared to the chord length 37 at that same chordwise plane, and not compared to the chord length at another chordwise plane at another spanwise position.

The chordwise distance 36 may preferably be measured from a midpoint of the rear reinforcement structure 25, i.e. a central point between the rear leeward reinforcing structure and the trailing rear windward reinforcing structure.

In case of a flatback airfoil, the chordwise distance 36 may preferably be measured (for a given chordwise plane) at the centre of the trailing edge, i.e., the centre of the substantially flat wall at the trailing edge.

FIG. 5 illustrates the chordwise distance 36 relative to the chord length along the spanwise direction of a wind turbine blade according to the present disclosure.

The horizontal axis of the figure provides the spanwise position relative to the span length from the root end to the tip end of the blade. Hence, “0%” corresponds to the root end of the blade, and “100%” (outside axis limits) corresponds to the tip end of the blade.

The vertical axis of the figure provides the chordwise distance between the rear reinforcement structure and the trailing edge relative to chord length from the trailing edge to the leading edge.

The illustrated curve thereby provides the chordwise distance between the rear reinforcement structure and the trailing edge relative to chord length along the spanwise direction of an exemplary wind turbine blade according to the present disclosure.

At each position along the spanwise direction (the horizontal axis), the chordwise distance relative to the chord length has been determined as outlined in relation to FIG. 4.

The start and end points of the curve along the horizontal axis further provides the start and end points of the rear reinforcement structure 25 along the spanwise direction. As also illustrated in FIG. 2, the start and end points of the rear reinforcement structure typically terminate at some distance relative to the root end and tip end of the blade.

As evident from FIG. 5, the chordwise distance relative to the chord length is typically greater in a mid-span section of the blade, whereas it decreases both towards the tip end and the root end of the blade. This is consistent with the exemplary windward shell illustrated in FIG. 2. Here, the distance from the trailing edge to the rear (windward) reinforcement structure also varies, being greater in a mid-span section.

The improved edgewise and/or torsional stiffness of the blade, which may be provided by a trailing edge reinforcement structure according to the present disclosure, are typically greater when the chordwise distance 36 is large. This may be quantified by a comparison of the chordwise distance 36 (relative to the chord length) with a chordwise gap 38, which is also illustrated in FIG. 5. In the present example, the chordwise gap is 30% of the chordwise length, and the chordwise distance 36 is greater than this chordwise gap 38 along a spanwise range 39, with the spanwise range being 30% of the span length of the blade.

Preferably, the trailing edge reinforcement structure extends at least entirely along this spanwise range 39 in which the chordwise distance 36 is greater than the chordwise gap 38. This is exemplified in FIG. 5 by a horizontal bar at the top of the figure indicative of the extent of the trailing edge reinforcement structure 30 along the spanwise direction. As illustrated, the trailing edge reinforcement structure 30 of the present example extends at least entirely along the spanwise range 39.

The position of the trailing edge reinforcement structure 30 in FIG. 5 is only indicative of the position along the spanwise direction, and not indicative of the position along the chordwise direction. Typically, along the chordwise direction, the trailing edge reinforcement structure is arranged between the rear reinforcement structure and the trailing edge.

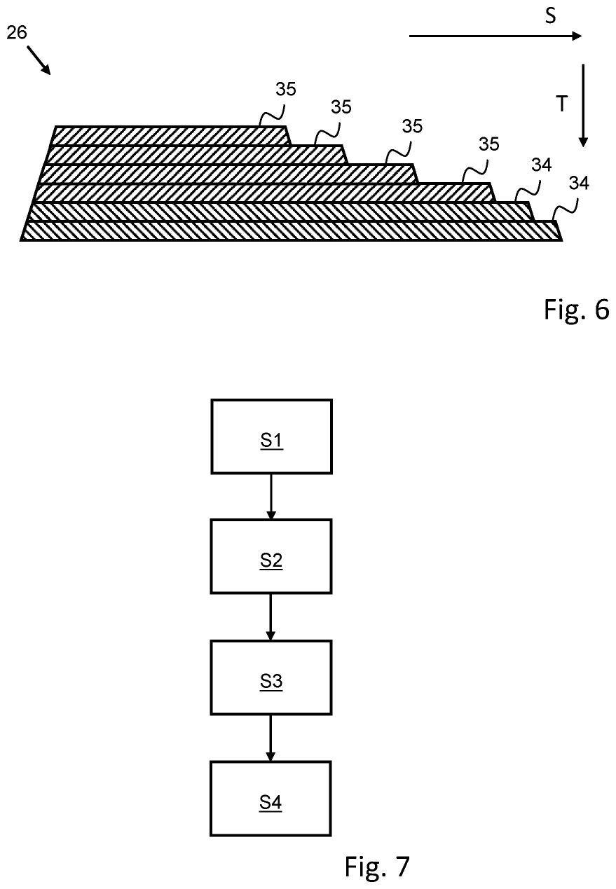

FIG. 6 illustrates a rear windward reinforcement structure 26 of an exemplary wind turbine blade according to the present disclosure.

The spanwise direction (“S”) and the thickness direction (“T”) of the blade relative to the reinforcement structure 26 in the blade are indicated in the illustration.

The rear windward reinforcement structure 26 comprises two layers of pultruded fibres of carbon 34 and four layers of pultruded fibres of glass 35 stacked on top of each other.

In the blade, the outermost layer of pultruded fibres of carbon 34 is aligned with an outer surface of the windward shell. It is nearer this outer surface of the windward shell than the other layers of pultruded fibres, including the layers of pultruded fibres of glass 35. In comparison, the innermost layer of pultruded fibres of glass 35 is aligned with an inner surface of the windward shell. This layer is nearer this inner surface of the windward shell than the other layers of pultruded fibres, including the layers of pultruded fibres of carbon 34.

Moreover, the layers of pultruded fibres of carbon 34 extend further in the spanwise direction towards the tip end of the blade than the layers of pultruded fibres of glass 35.

In a similar manner, a rear leeward reinforcement structure can comprise layers of pultruded fibres of carbon and layers of pultruded fibres of glass stacked on top of each other, in which an outermost layer of pultruded fibres of carbon is nearer the outer surface of the leeward shell than the other layers of pultruded fibres of the rear leeward reinforcement structure including the layers of pultruded fibres of glass, and the innermost layer of pultruded fibres of glass is nearer the inner surface of the leeward shell than the other layers of pultruded fibres of the rear leeward reinforcement structure including the layers of pultruded fibres of carbon. Additionally, the layers of pultruded fibres of carbon of the rear leeward reinforcement structure can extend further in the spanwise direction towards the tip end of the blade than the layers of pultruded fibres of glass.

Generally, the geometry near the trailing edge of the blade can restrict the room available for layers of pultruded fibre, in particular since layers of pultruded fibres tend to follow a straight path which cannot follow the typical shape of the trailing edge along the spanwise direction. The provision of layers of pultruded fibres of, e.g., carbon which extend further and/or which are nearer an outer surface of the blade may advantageously ensure that the room available is utilized by layers of pultruded fibres of carbon.

FIG. 7 illustrates a flow chart of a method of manufacturing a wind turbine blade according to an embodiment of the present disclosure.

In a step S1 of the method, a main windward reinforcement structure is engaged with a windward shell, and a main leeward reinforcement structure is engaged with a leeward shell. The main windward reinforcement structure and the main leeward reinforcement structure comprise layers of pultruded fibres of a first material, for example layers of pultruded fibres of carbon.

In another step S2 of the method, a rear windward reinforcement structure is engaged with the windward shall, and a rear leeward reinforcement structure is engaged with a leeward shell. The rear windward reinforcement structure and/or the rear leeward reinforcement structure comprise layers of pultruded fibres of a second material, for example layers of pultruded fibres of glass. The pultruded fibres of the first material have a Young's modulus greater than the pultruded fibres of the second material

In another step S3 of the method, the wind turbine blade is formed from the leeward shell and the windward shell such that the wind turbine blade extends in a spanwise direction between a root end and a tip end of the blade, in a thickness direction between the leeward shell and the windward shell, and in a chordwise direction between a leading edge and a trailing edge. As the blade has been formed, the main windward reinforcement structure, the main leeward reinforcement structure, the rear windward reinforcement structure, and the rear leeward reinforcement structure each extend in the spanwise direction of the blade. Further, the main windward reinforcement structure and the main leeward reinforcement structure forms a main reinforcement structure, for example interconnected by a main web. The rear windward reinforcement structure and the rear leeward reinforcement structure forms a rear reinforcement structure, for example interconnected by a rear web. The rear leeward reinforcement structure is arranged between the main reinforcement structure and the trailing edge.

In another step S4 of the method, the wind turbine blade is engaged with a trailing edge reinforcement structure such that the trailing edge reinforcement structure extends in the spanwise direction and is arranged between the rear reinforcement structure and the trailing edge.

The trailing edge reinforcement structure comprises fibres of a trailing edge reinforcement material. Moreover, these fibres engage the leeward shell and/or the windward shell. Typically, the trailing edge reinforcement material is glass, such that the fibres of the trailing edge reinforcement structure are fibres of glass.

Generally, the engagement of a reinforcement structure with a shell may be implemented by integration into the shell (for example during infusion), or by bonding to the shell (for example, after moulding the shell). Such bonding may for example be implemented by adhesion or other well-known fastening means.

Thereby, a more cost-efficient wind turbine blade may be manufactured.

The method steps are not limited to any particular sequence of execution and may further, in principle, be performed at least partly simultaneously.

Various versions and elements of the invention have been exemplified for the purpose of clarification rather than limitation. Well-known details of methods and systems have been omitted to not obscure the content of the disclosure with redundancy. Various elements and features of the invention and this disclosure may be combined in any way possible within the scope of the claims.

1. A wind turbine blade comprising:
a root end and a tip end, the blade extending in a spanwise direction between the root end and the tip end;
a leading edge and a trailing edge, the blade extending in a chordwise direction between the leading edge and the trailing edge;
a leeward shell and a windward shell, the blade extending in a thickness direction between the leeward shell and the windward shell;
a main reinforcement structure, the main reinforcement structure comprising a main windward reinforcement structure engaging the windward shell and extending in the spanwise direction of the blade and a main leeward reinforcement structure engaging the leeward shell and extending in the spanwise direction of the blade;
a rear reinforcement structure, the rear reinforcement structure comprising a rear windward reinforcement structure engaging the windward shell and extending in the spanwise direction of the blade and a rear leeward reinforcement structure engaging the leeward shell and extending in the spanwise direction of the blade, the rear reinforcement structure being arranged between the main reinforcement structure and the trailing edge; and
a trailing edge reinforcement structure extending in the spanwise direction of the blade and being arranged between the rear reinforcement structure and the trailing edge;
wherein:
the main windward reinforcement structure and the main leeward reinforcement structure comprise layers of pultruded fibres of a first material;
the rear windward reinforcement structure and/or the rear leeward reinforcement structure comprise layers of pultruded fibres of a second material, the pultruded fibres of the first material having a Young's modulus greater than the pultruded fibres of the second material; and
the trailing edge reinforcement structure comprises fibres of a trailing edge reinforcement material aligned with the trailing edge of the blade and engaging the leeward shell and/or the windward shell.

2. The wind turbine blade according to claim 1, wherein the pultruded fibres of the first material have a Young's modulus greater than the fibres of the trailing edge reinforcement material.

3. The wind turbine blade according to claim 1, wherein the first material is carbon.

4. The wind turbine blade according to claim 1, wherein the second material and/or the trailing edge reinforcement material is glass.

5. The wind turbine blade according to claim 1, wherein the fibres of the trailing edge reinforcement material in the trailing edge reinforcement structure are primarily unidirectionally arranged in a fabric of material.

6. The wind turbine blade according to claim 5, wherein the fabric of material is in the form of tape.

7. The wind turbine blade according to claim 1, wherein the trailing edge reinforcement structure forms skins around a sandwich core of the leeward shell and/or the windward shell.

8. The wind turbine blade according to claim 1, wherein the rear reinforcement structure comprises layers of pultruded fibres of the first material.

9. The wind turbine blade according to claim 6, wherein, in the rear reinforcement structure, the layers of pultruded fibres of the first material are nearer an outer surface of the blade than the layers of pultruded fibres of the second material.

10. The wind turbine blade according to claim 6, wherein, in the rear reinforcement structure, the layers of pultruded fibres of the first material extend further in the spanwise direction towards the tip end than the layers of pultruded fibres of the second material.

11. The wind turbine blade according to claim 1, within an airfoil section of the wind turbine blade, the main windward reinforcement structure and the main leeward reinforcement structure have a first average Young's modulus in the spanwise direction and the rear windward reinforcement structure and the rear leeward reinforcement structure have a second average Young's modulus in the spanwise direction, wherein the first average elastic modulus and the second average elastic modulus are determined with respect to unit area of the respective reinforcement structure perpendicular to the spanwise direction, wherein a ratio of the first average Young's modulus to the second average Young's modulus is between 1.1 and 2.6.

12. The wind turbine blade according to claim 1, wherein along at least a part of an extension of the trailing edge reinforcement structure along the spanwise direction, a chordwise distance between the rear reinforcement structure and the trailing edge in the chordwise direction is greater than a chordwise gap, wherein the chordwise gap is at least 15% of a chord length from the trailing edge to the leading edge.

13. The wind turbine blade according to claim 12, wherein the chordwise distance is greater than the chordwise gap within an entirety of a spanwise range along the spanwise direction, wherein the spanwise range is at least 20% of a spanwise length from the root end to the tip end.

14. A method for manufacturing a wind turbine blade, the method comprising the steps of:
engaging a main windward reinforcement structure with a windward shell and a main leeward reinforcement structure with a leeward shell, wherein the main windward reinforcement structure and the main leeward reinforcement structure comprise layers of pultruded fibres of a first material;
engaging a rear windward reinforcement structure with the windward shell and a rear leeward reinforcement structure with the leeward shell, wherein the rear windward reinforcement structure and/or the rear leeward reinforcement structure comprise layers of pultruded fibres of a second material, the pultruded fibres of the first material having a Young's modulus greater than the pultruded fibres of the second material;
forming the wind turbine blade from the leeward shell and the windward shell such that the wind turbine blade extends in a spanwise direction between a root end and a tip end of the blade, in a thickness direction between the leeward shell and the windward shell, and in a chordwise direction between a leading edge and a trailing edge of the blade,
wherein the main windward reinforcement structure, the main leeward reinforcement structure, the rear windward reinforcement structure, and the rear leeward reinforcement structure each extend in the spanwise direction of the blade,
wherein the main windward reinforcement structure and the main leeward reinforcement structure forms a main reinforcement structure and the rear windward reinforcement structure and the rear leeward reinforcement structure forms a rear reinforcement structure arranged between the main reinforcement structure and the trailing edge; and
engaging a trailing edge reinforcement structure with the wind turbine blade such that the trailing edge reinforcement structure extends in the spanwise direction and is arranged between the rear reinforcement structure and the trailing edge,
wherein the trailing edge reinforcement structure comprises fibres of a trailing edge reinforcement material aligned with the trailing edge of the blade and engaging the leeward shell and/or the windward shell.

15. (canceled)
